(19) United States
(12) Patent Application Publication
(10) Pub. No.: US 2008/0267595 A1
(43) Pub. Date: Oct. 30, 2008

(54) Recording Medium and Apparatus and Method for Recording and Reproducing Data on the Same

(75) Inventors: Kang Soo Seo, Gyeonggi-do (KR); Sung Wan Park, Gyeonggi-do (KR); Byung Jin Kim, Gyeonggi-do (KR)

Correspondence Address: HARNESS, DICKEY & PIERCE, P.L.C., P.O. BOX 8910, RESTON, VA, 20195, US

(73) Assignee: LG ELECTRONICS INC., Seoul (KR)

(21) Appl. No.: 11/579,331

(22) PCT Filed: May 4, 2005
(86) PCT No.: PCT/KR05/01300

§ 371 Date: May 19, 2008

(30) Foreign Application Priority Data
May 4, 2004 (KR) 10-2004-0031258

(51) Int. Cl. H04N 5/00

(52) U.S. Cl. 386/126; 386/E05.001

(57) ABSTRACT

AV stream files and management files are initially recorded in a data recordable area (open), which is included in a user data area of an optical disc. File system information is further recorded in the data recordable area after the recordation of the management files, where the file system information is associated with the AV stream files and the management files. After the recordation of the file system information, the data recordable area is closed. Attribute information including last recorded address of the closed data area is recorded in a temporary disc management area of the optical disc.

### TECHNICAL FIELD

The present invention relates to a recording medium, and more particularly, to a recording medium and an apparatus and method for recording and reproducing data on the same. Although the present invention is suitable for a wide scope of applications, it is particularly suitable for recording and reproducing reliable data of a write-once recording medium.

### BACKGROUND ART

Optical discs are widely used as a recording medium for recording mass data. Presently, among a wide range of optical discs, a new high-density optical recording medium, such as a Blu-ray Disc (hereinafter referred to as “BD”), is under development for writing and storing high definition video and audio data. Currently, global standard technical specifications of the Blu-ray Disc (BD), which is known to be the next generation technology, are under establishment as a next generation optical recording solution that is able to record and store data significantly surpassing the conventional DVD, along with many other digital apparatuses.

Accordingly, the write-once blu-ray disc (BD-WO) is currently under discussion as the blu-ray disc standard. However, since the Blu-ray Disc (BD-WO) standards are yet to be completed, there have been many difficulties in developing a complete optical recording and reproducing apparatus. More specifically, in order to efficiently reproduce the data recorded on the blu-ray disc (BD-WO), a file system information for managing the files having data recorded therein is necessary and should be provided by a systematic and standardized method. However, in the current blu-ray disc (BD-WO) standard, since a consolidated standard for the method for recording and reproducing the and the file system information has not been completed, there still remain many restrictions in fully developing blu-ray disc (BD)-based optical recording and reproducing apparatuses.

### DISCLOSURE OF INVENTION

An object of the present invention devised to solve the problem lies on providing a recording medium and an apparatus and method for recording and reproducing data on the same that can substantially obviate one or more problems due to limitations and disadvantages of the related art.

Another object of the present invention devised to solve the problem lies on providing a method and apparatus for recording data on a new recordable area after recording a file system information on a recording medium and changing the corresponding recordable area to a non-recordable area.

A further object of the present invention devised to solve the problem lies on providing a method for recovering reliable data from a recording medium having the above-described data recorded therein.

The object of the present invention can be achieved by providing a method for recording data on a recording medium having a user data area and a temporary disc management area including recording AV stream files and management files in a data recordable area included in the user data area, recording file system information in the data recordable area after the recording (or recordation) of the management files, the file system information being associated with the AV stream files and the management files recorded in the data recordable area, closing the data recordable area after the recording (or recordation) of the file system information in the data recordable area, and recording attribute information of the closed data area in the temporary disc management area, wherein the attribute information comprises last recorded address information of the closed data area.

Herein, the management files may include at least one of information, menu, mark, playlist, and clip information files required for reproducing the AV stream files stored in the data recordable area. And, the file system information may include at least one of volume structure information and file structure information. The volume structure information may include volume structure descriptors and anchor information indicating locations of the volume structure descriptors. The file structure information may include metadata files and a first file entry indicating locations of the metadata files. And, the first file entry may include a metadata partition map if any one of the metadata files is partitioned, the metadata partition map indicating locations of the partitioned metadata file. Finally, the file structure information may further include metadata mirror files and a second file entry indicating locations of the metadata mirror files.

In another aspect of the present invention, provided herein is, a recording medium for recording data including a temporary disc management area, and a user data area comprising a data recordable area, the data recordable area being configured to store AV stream files and management files and to store file system information associated with the AV stream files and the management files, wherein the user data area is configured to be closed after the file system information is stored, and the temporary disc management area is configured to store attribute information of the closed data area, the attribute information comprising last recorded address information of the closed data area.

In another aspect of the present invention, provided herein is, an apparatus for recording data on a recording medium having a user data area and a temporary disc management area including a driver configured to drive an optical recording device to record data on a recording medium, and a controller configured to control the driver to record AV stream files and management files in a data recordable area included in the user data area and to record associated file system information in the data recordable area after the recordation of the management files, wherein the controller is configured to control the driver to close the data recordable area after the file system information is stored in the data recordable area and to store attribute information of the closed data area in the temporary disc management area, the attribute information comprising last recorded address information of the closed data area.

In another aspect of the present invention, provided herein is, a method for reproducing data recorded on a recording medium having a user data area and a temporary disc management area including reading attribute information of a closed data area from the temporary disc management area, wherein the closed data area is included in the user data area and the attribute information comprises last recorded address information of the closed data area, reading file system information recorded in the closed data area using the last recorded address information, and reproducing AV stream files recorded in the closed data area using the last recorded address information and the file system information.

In a further aspect of the present invention, provided herein is, an apparatus for reproducing data recorded on a recording medium having a user data area and a temporary disc management area including a driver configured to drive an optical reproducing device to reproduce data recorded on the recording medium, and a controller configured to control the driver to read attribute information of a closed data area from the temporary disc management area, to read file system information recorded in the closed data area using last recorded address information included in the attribute information, and to reproduce AV stream files recorded in the closed data area using the last recorded address information and the file system information, the closed data area being included in the user data area.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 illustrates a single-layer structure of a write-once optical disc according to the present invention.

FIGS. 2A to 2D illustrate various types of open SRRs of the write-once optical disc according to the present invention.

FIGS. 3A to 3C illustrate various types of closed SRRs of the write-once optical disc according to the present invention.

FIG. 4 illustrates a method for recording data on a multi-session applicable to the present invention.

FIG. 5 illustrates a file structure of a write-once optical disc that is applicable to the present invention.

FIG. 6A to FIG. 7 illustrate a disc recording method of the write-once optical disc according to the present invention.

FIG. 8 illustrates an optical recording and reproducing apparatus according to the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium that can record data and broadly includes all types of medium regardless of the recording method, such as an optical disc, a magnetic tape, and so on. Hereinafter, for simplicity of the description of the present invention, the optical disc and, more specifically, the “Blu-ray disc (BD)” will be given as an example of the recording medium proposed herein. However, it will be apparent that the spirit or scope of the present invention may be equally applied to other types of recording medium. Additionally, in the present invention, a “file system” refers to a set of information not only managing a logical structure (hereinafter referred to as a “Disc Volume”) of the entire optical disc, but also managing all of the files recorded within the optical disc. Herein, such information is only recognized by the system and not recognized by the user.

A “File System Information” includes volume structure information and file structure information. The volume structure information includes volume structure descriptors defining the structure of a disc volume, and it further includes anchor information (Anchor) indicating the locations of the volume structure descriptors. On the other hand, the file structure information includes location and attribute information of various data files recorded on the disc. For example, the file structure information may include metadata files (MD Files) and a metadata-file file entry (MD File FE) which indicates the locations of the metadata files. If a metadata file is partitioned (scattered) within the disc, the metadata-file file entry may include a metadata partition map which indicates the location of the partitioned metadata file. In addition, the file structure information may further include metadata mirror files (MD Mirror Files), which are backup files of the metadata files, and a metadata-mirror-file file entry (MDM File FE) indicating the locations of the metadata mirror files.

Accordingly, the types of file systems that can be applied to the optical disc may be diverse in accordance with the attributes of the optical disc standard. And, the most commonly used file system type is a “Universal Disc Format (UDF)”, which will be given as an example for describing the present invention. Additionally, in the present invention, a “management File” refers to a file for recording reproduction management information for reproducing stream files that are recorded by a user. The management File will be described in detail with reference to FIG. 5.

The present invention relates to providing various methods of allocating recordable areas within a write-once optical disc and closing the recordable areas to non-recordable areas, after recording the file system information within the corresponding areas, thereby using a next recordable area. A detailed description of the present invention will now follow with reference to the accompanying drawings.

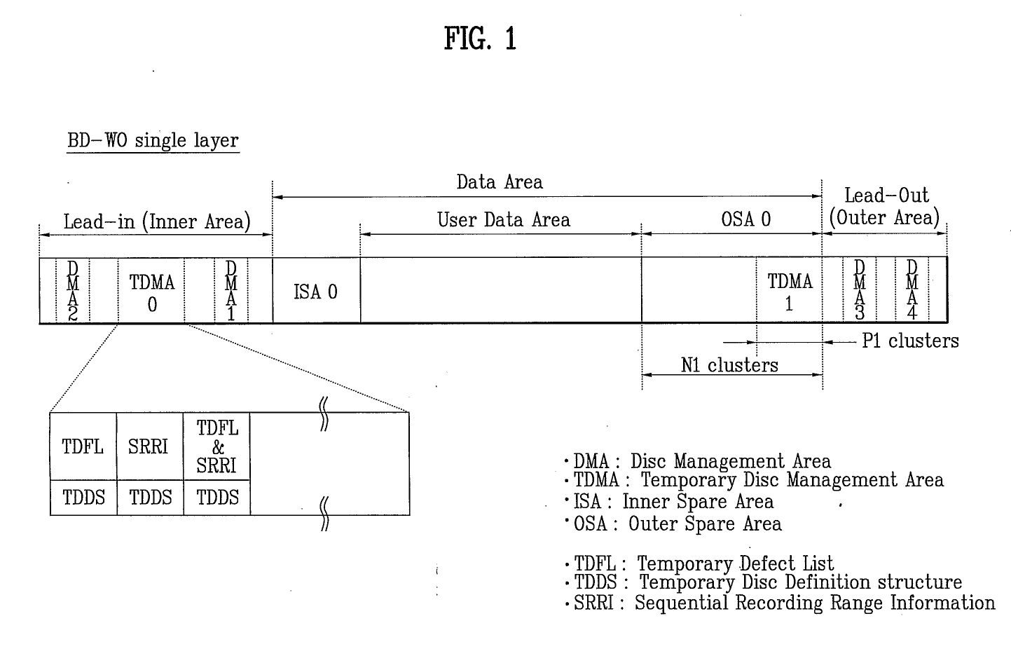

FIG. 1 illustrates a single-layer structure of a write-once blu-ray disc (BD-WO) according to the present invention. Referring to FIG. 1, the write-once optical disc is includes a spare area, a Temporary Disc Management Area (TDMA), and a Disc Management Area (DMA). More specifically, the spare area is used for managing defects, the TDMA is for recording management information prior to finalization (or closing) of the disc, and the DMA is for recording a final management information after the finalization (or closing) of the disc.

Due to the characteristics of the write-once optical disc, defect management information, which occurs during the usage of the disc, and general management information, which indicate the recording status within the disc, are both included in the TDMA. And, when the disc is finalized, recording can no longer be performed on the corresponding disc, and so the final management information of the TDMA is relocated to the DMA. Accordingly, there are two types of TDMA: TDMA0 and TDMA1. The TDMA0 has a fixed size (e.g., 2048 clusters) within a Lead-in area and can be allocated whenever the disc is initialized. The TDMA1 has a variable size that is associated with the size of an Outer Spare Area 0 (OSA0) (i.e., N1 clusters) within the Outer Spare Area (OSA) having a variable size among the spare areas within the data zone. Herein, allocation of the TDMA1 is decided when initializing the disc, and when allocation is decided, the TDMA1 that is to be used exists after the use of the TDMA0 is completed.

The disc management information is recorded in the TDMA (TDMA0, TDMA1), the types of the disc management information being recorded in the TDMA of the write-once optical disc according to the present invention are illustrated in the lower portion of FIG. 1. Additionally, the disc management information includes 3 types: a Temporary Defect List, a Sequential Recording Range information, and a Temporary Disc Definition Structure. The Temporary Defect List (hereinafter referred to as “TDFL”) is a defect management information recording a defect list for managing a defect area of the disc. The Sequential Recording Range Information (hereinafter referred to as “SRRI”) indicates a recording status within the disc in a Sequential Recording Mode (SRM). Finally, the Temporary Disc Definition Structure (hereinafter referred to as “TDDS”) records various types of necessary information within the disc including a pointer for designating positions of a recent TDFL and SRRI.

Moreover, the management information is recorded in the TDMA whenever the information are required to be updated. Most particularly, since the most recent information should always be recorded in the TDDS, all updated information is recorded in the TDDS as well as one of the TDFL and the SRRI. However, it is preferable that the updated information is recorded to have the size of 1 sector. Furthermore, when recordable user data area or TDMA no longer remains in the disc, or when the user no longer desires recording to be performed on the disc, the disc is finalized, and, among the management information recorded in the TDMA, the last management information that has been most recently recorded in reallocated to the DMA and recorded therein.

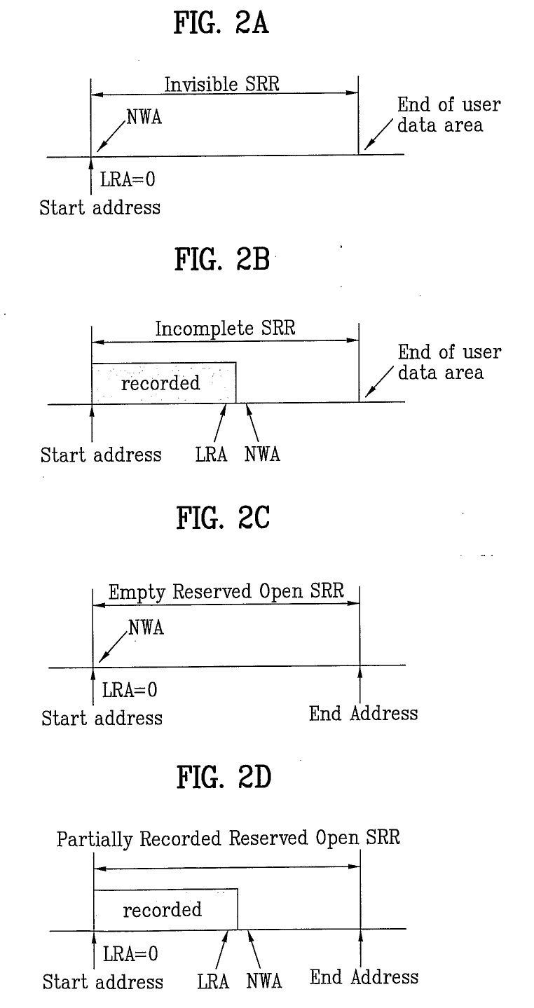

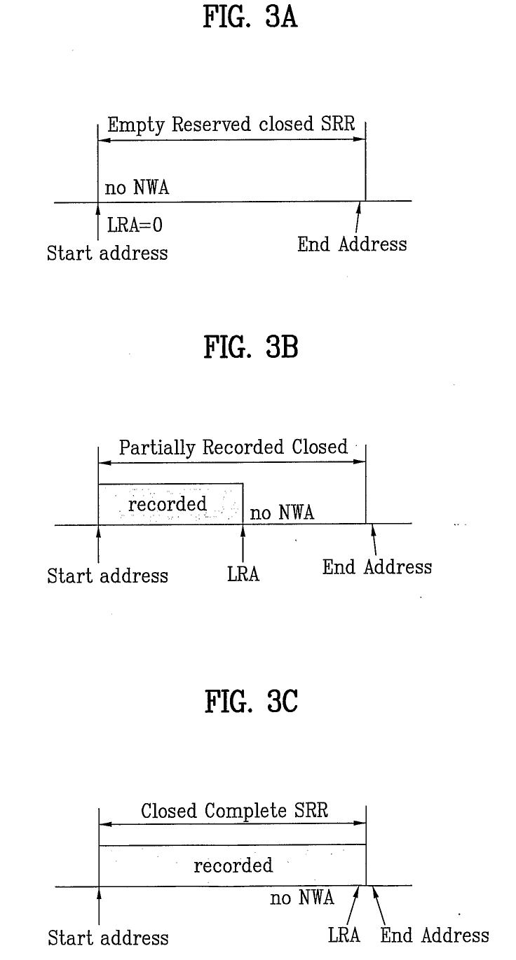

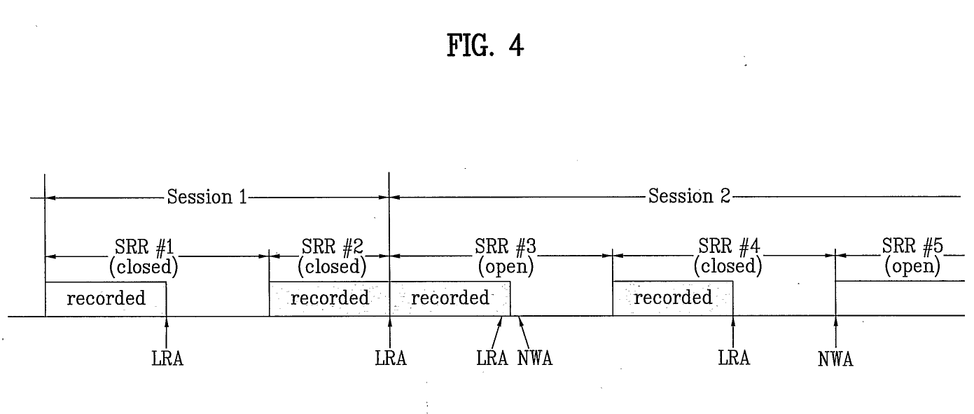

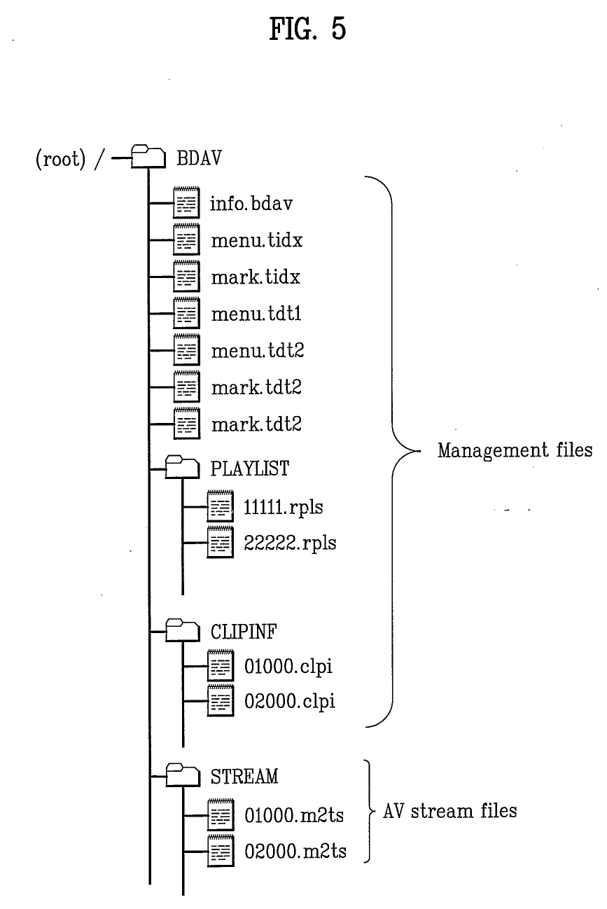

Hereinafter, various types of Sequential Recording Ranges allocated within the disc for a Sequential Recording Mode on the write-once optical disc according to the present invention and a recording method using such Sequential Recording Ranges will now be described in detail. First of all, the Sequential Recording Range (hereinafter referred to as “SRR”) refers to an area allocated for recording data within the write-once optical disc such as the BD-WO. The types of SRRs may be diversely defined as required or while performing data recording, which are illustrates in FIGS. 2A to 2D. FIGS. 2A to 2D illustrate various types of open SRRs of the write-once optical disc according to the present invention. An open SRR refers to an SRR on which data can be recorded in a corresponding area. And, an SRR that can be recorded indicates that a Next Writable Address (NWA) is included in the SRR. Therefore, the open SRR refers to an SRR having an NWA, and an SRR that does not have an NWA and that cannot be recorded is a closed SRR. The closed SRR will be described in detail with reference to FIGS. 3A to 3C in a later process.

FIG. 2A illustrates an Invisible SRR, which is a first type of open SRRs. Referring to FIG. 2A, the Invisible SRR refers to an SRR that is always formed on an outermost circumferential region of the disc or on a first blank disc. In other words, the Invisible SRR refers to an area on which data recording has not yet been performed. More specifically, only a start address is defined in the Invisible SRR, and the end of this area will correspond to an end of the user data area. Also, as data recording has not yet been performed, “Last Recorded Area (LRA)=0” indicating the location of the last recorded area is included in the Invisible SRR, and the NWA has the same value as a start address. FIG. 2B illustrates an Incomplete SRR, which is a second type of open SRRs. The Incomplete SRR refers to data recording being partially performed on the Invisible SRR of FIG. 2A. More specifically, only a Start address is defined in the Incomplete SRR, just as in the Invisible SRR, and an end of the area is the End of the user data area. However, as data recording is partially performed, the LRA indicates the last position in which normal data is recorded. Therefore, the NWA becomes a set of information corresponding to a fore-end position of a cluster following the LRA.

FIG. 2C illustrates an Empty open SRR, which is a third type of open SRRs. Unlike the Invisible SRR and the Incomplete SRR shown in FIG. 2A and FIG. 2B, the Empty open SRR refers to an SRR formed in a middle region of the disc, and not the outermost circumferential region of the disc, for recording data. More specifically, the Empty open SRR corresponds to when a user or a host creates an open SRR for recording data but does not yet perform the recordation of data. In other words, since the open SRR is provided with unrecorded Start address and End address, the LRA is equal to ‘0’ (i.e., LRA=0), and the NWA value is equal to the Start address. FIG. 2D illustrates a Partially recorded open SRR, which is a fourth type of open SRRs. Referring to FIG. 2D, the Partially recorded open SRR refers to the Empty open SRR of FIG. 2C being partially recorded. Therefore, the Partially recorded open SRR is provided with a Start address and an End address. And, as data recording is partially performed, the LRA indicates the last position in which normal data is recorded. Therefore, the NWA becomes a set of information corresponding to a fore-end position of a cluster following the LRA. In the write-once optical disc, the number of the above-described open SRRs may be restricted. Accordingly, a maximum of 16 open SRR may be included in the write-once blu-ray disc (BD-WO).

FIGS. 3A to 3C illustrate various types of closed SRRs of the write-once optical disc according to the present invention. Herein, a “closed SRR” refers to an SRR wherein data recording is impossible (or cannot be performed) in the corresponding area, and data recording being “impossible” means that the SRR does not have a “Next Writable Address (NWA)” information. The closed SRR may be formed either when all data recording is completed in the corresponding area, or when the SRR is forcibly closed in accordance with a closing command made by the user or the host, even when recordable area still remain in the corresponding area.

FIG. 3A illustrates an Empty closed SRR, which is a first type of closed SRRs. Referring to FIG. 3A, the Empty closed SRR corresponds to the Empty open SRR of FIG. 2C being closed, in accordance with a closing command, without data recording. FIG. 3B illustrates a Partially recorded closed SRR, which is a second type of closed SRRs. Referring to FIG. 3B, the Partially recorded closed SRR refers to the Partially recorded open SRR of FIG. 2D being closed, in accordance with a closing command. And, FIG. 3C illustrates a complete SRR, which is a third type of closed SRRs. Referring to FIG. FIG. 3C, the complete SRR refers to an SRR in which recordation of normal user data is fully completed until the end of the corresponding area.

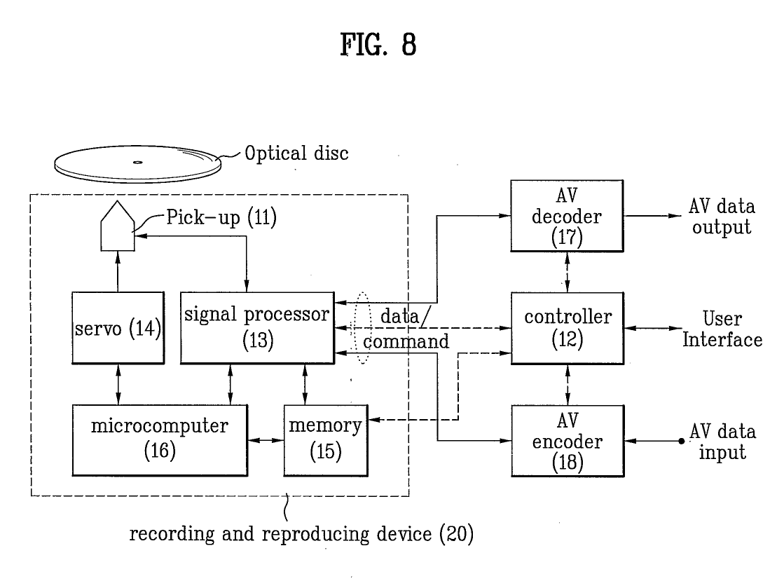

The information on each of the SRRs described in FIG. 2A to FIG. 3C is the SRRI that is recorded in the TDMA. Information on all open SRRs included in the current disc and information of the Start address and LRA of all SRRs are recorded in the SRRI. Thus, by acquiring the most recent SRRI, the optical recording and reproducing apparatus (shown in FIG. 8) is capable of reading information on the recordable areas (open SRRs) and the recording-completed areas (closed SRRs) within the current disc. Accordingly, by using the read information, recording and reproduction can be performed on the write-once optical disc.

FIG. 4 illustrates an example of a method for recording data by using the SRR and an example of applying a session according to the present invention. Herein, a “session” refers to a recording unit consisting of at least one SRR and being of a level higher than the SRR. Generally, a plurality of sessions, which is also referred to as a multi-session, may be applied in an optical disc. When the multi-session is applied, only the last session becomes the recordable session, whereas all of the previous sessions are closed. Accordingly, all of the SRRs existing within the previous sessions become closed SRRs. For example, when SRR #1 and SRR #2 are initially allocated within session 1 of the disc and the corresponding session 1 is eventually ended (or closed), and when the user or host wishes to open a new session 2, the SRR #1 and SRR #2 of the previous session 1 become closed SRRs, so that data recording can no longer be performed thereon.

Subsequently, when SRR #3 and SRR #4 are allocated within the newly open session 2, SRR #5 automatically becomes the Invisible open SRR, and so SRR #3, SRR #4, and SRR #5 would all become recordable areas. However, FIG. 4 illustrates an example of the SRR #4 forcibly becoming a closed SRR in accordance with a closing command from the user or host, so that data recording can no longer be performed on the SRR #4. More specifically, in a recordable session, at least one open SRR is sufficient, and so all of the SRRs existing in the recordable session do not necessarily have to be open SRRs. Therefore, the final recording status of the disc, shown in FIG. 4, can be verified from the SRRI recorded on the TDMA. And, from the recording status information within the SRRI, it can be known that session 2 is currently being used and that SRR #3 and SRR #5 within session 2 are recordable areas (open SRRs). It can also be known that session 1 is an area in which data recording has already been completed.

FIG. 5 illustrates a file structure applicable to write-once optical disc according to the present invention. Referring to FIG. 5, at least one BD directory (BDAV) is included in a root directory (root). Each BD directory includes an info file (info.bdav), menu files (menu.tidx, menu.tdt1, menu.tdt2), and mark files (mark.tidx, mark.tdt1, mark.tdt2), which represent general files that are used when interacting with one or more users. Each BD directory includes three file directories including data to be reproduced, and information required for reproducing the data. The file directories included in each BD directory are a stream directory (STREAM), a playlist directory (PLAYLIST), and a clip information directory (CLIPINF). The stream directory includes audio/video (AV) stream (hereinafter referred to as “AV stream”) files. More specifically, the AV streams (01000.m2ts, 02000.m2ts) are generally recorded on a specific area within the disc and represent AV data (or PC data).

Further, the clip information directory (CLIPINF) includes clip information files (*.clpi) being in one-to-one correspondence with each of the stream files (*.m2ts) included in the stream directory. A clip information file (*.clpi) includes property information and timing information of a corresponding stream file (*.m2ts). In the BD standard, each pair of a stream file (*.m2ts) and its corresponding clip information file (*.clpi), which are in one-to-one correspondence with one another, is designated as a “clip”. For example, 01000.clpi included in the CLIPINF includes the property information of 01000.m2ts included in the STREAM, and 01000.clpi and 01000.m2ts form a clip.

Referring back to FIG. 2, the playlist directory (PLAYLIST) includes one or more PlayList files (*.rpls), wherein each PlayList file (*.rpls) includes at least one PlayItem which performs reproduction of a specific original clip. Thus, the PlayList file (*.rpls) represents playing-back (or reproducing) a desired clip combination from a combination of one or more PlayItems. More specifically, in the above-described file structure, the stream files included in the STREAM refers to files having actual user data recorded therein (i.e., AV stream files). And, the remaining directories and files are described as Management files, which include reproduction management files for reproducing the stream files. Additionally, since the Management files are information absolutely necessary for reproducing the stream files, the Management files require highly reliable protection. Accordingly, a “BACKUP directory” is provided under the BDAV directory, thereby recording backup management files within the BACKUP directory. Therefore, according to the file structure of the present invention, there are two types of Management files being recorded on the disc, each of which will be referred to as an “Original Management file” and a “Backup Management file”.

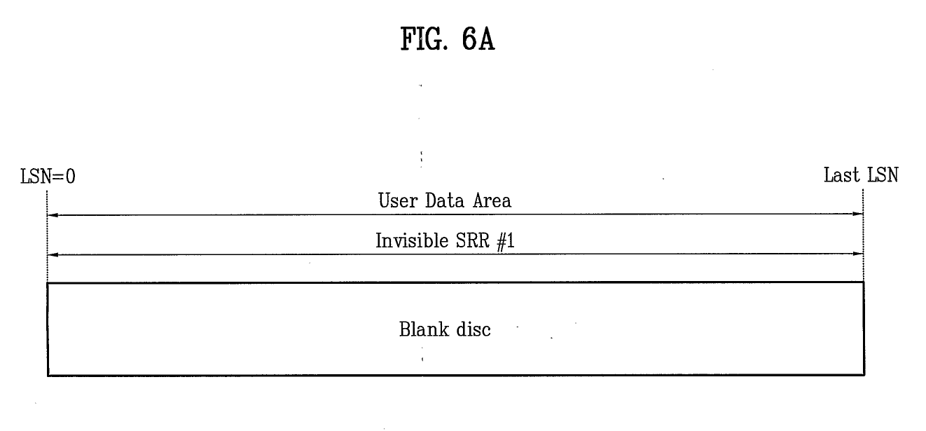

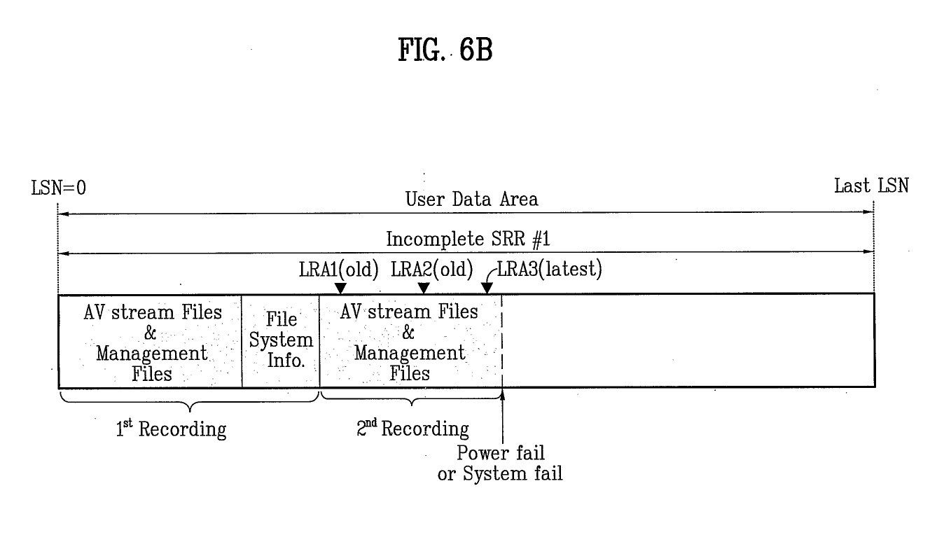

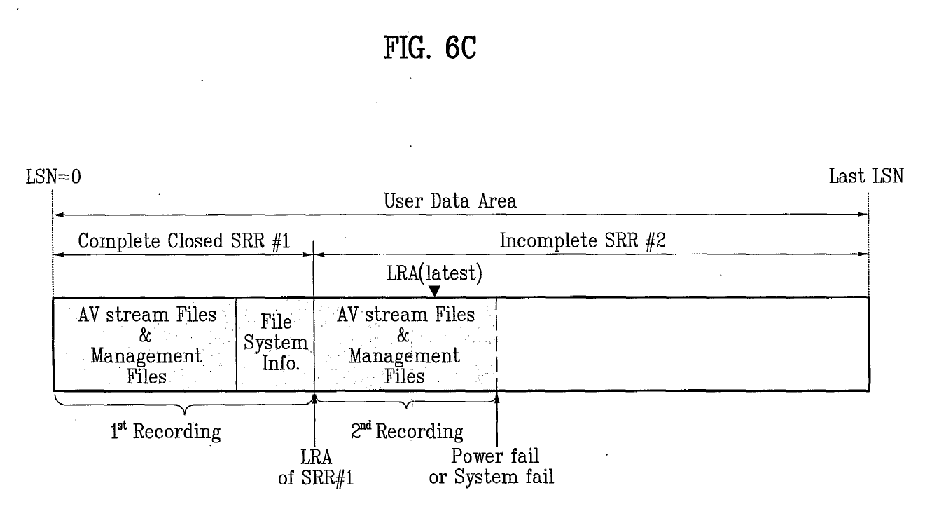

Hereinafter, a method and apparatus for recording and reproducing data on a write-once optical disc by using the above-described SRRs and file system will now be described in detail with reference to FIG. 6A to FIG. 8.

FIG. 6A illustrates a blank disc of an initial optical disc. Referring to FIG. 6A, no recording has been performed on the user data area, and an initial Invisible SRR is created so as to allow data to be recorded from the beginning of the optical disc. FIG. 6B illustrates a specific set of data desired by the user being recorded on the blank disc of FIG. 6A. More specifically, a specific AV stream and management files are recorded by a first recording process. Then, after the recordation of the file system information is completed, a second recording process is performed.

However, while performing the second recording process, recording may no linger be performed due to unexpected critical error, such as a power failure or a system failure. Thus, after the system has been normally reinstated, the system will eventually search for a Last Recording Address (LRA) of the previous recording. For example, if the system error is occurred during the second recording after being updated in the order of LRA1 (old)→LRA2 (old)→LRA3 (latest), the optical recording and reproducing apparatus will attempt to recover the data based on LRA3 (latest) after the system has been reinstated. However, since a valid file system information has not been recorded in the corresponding area (LRA3), the data that was being recorded during the second recording and the data for which recording has been completed during the first recording may not be fully reproduced.

FIG. 6C illustrates a method for recording data on the write-once optical disc according to an embodiment of the present invention. For example, in a situation such as that described in FIG. 6B, in order to enable at least the previous recording-completed data (e.g., data of the first recording) to be validly recovered, the corresponding SRR should be changed to a closed SRR after the recordation of the file system information. Thereafter, a newly open SRR is to be used when performing the second recording. More specifically, when the first recording is completed and the file system information is recorded afterwards, the corresponding area is changed to a closed SRR. Subsequently, the LRA information of the corresponding SRR and the SRRI of the TDMA are recorded.

Thereafter, when the second recording is performed on a new open SRR, and when an unexpected error occurs during the second recording, as described above, due to which recording (or recordation) of data can no longer be performed, and when the system is reinstated back to normal, the system eventually searches for the most recently updated LRA (latest). However, since the file system information has not yet been recorded during the second recording, the data of the second recording area cannot be validly recovered. Nevertheless, as the first recording area is already changed to a closed SRR #1 and a valid LRA information can be read from the SRRI of the TDMA, the file system information recorded during the first recording may be read from the LRA of the closed SRR #1, which is read. And so, by reproducing the “Anchor” and the “Volume structure” from the read file system information, the data validly recorded in the first recording area can be recovered.

When the above-described process is applied to the recording (or recordation) of the entire disc, the SRR on which the file system information is recorded is forcibly changed to a closed SRR. Thus, by reading the LRA of the closed SRR within the disc, the file system information may be validly read. And, as the normal data of the recording-completed area (i.e., the area up to which the file system information is read) can be recovered, a maximum portion of the data can be recovered even under emergency circumstances, such as unexpected system errors. More specifically, when the file system information is continuously updated and recorded within the entire disc, it is preferable to update only the currently recorded file for the “Metadata File”, among the file system information, and to manage the position of the “Metadata File” existing within the previously recorded file system information by using the “Metadata Partition Map”.

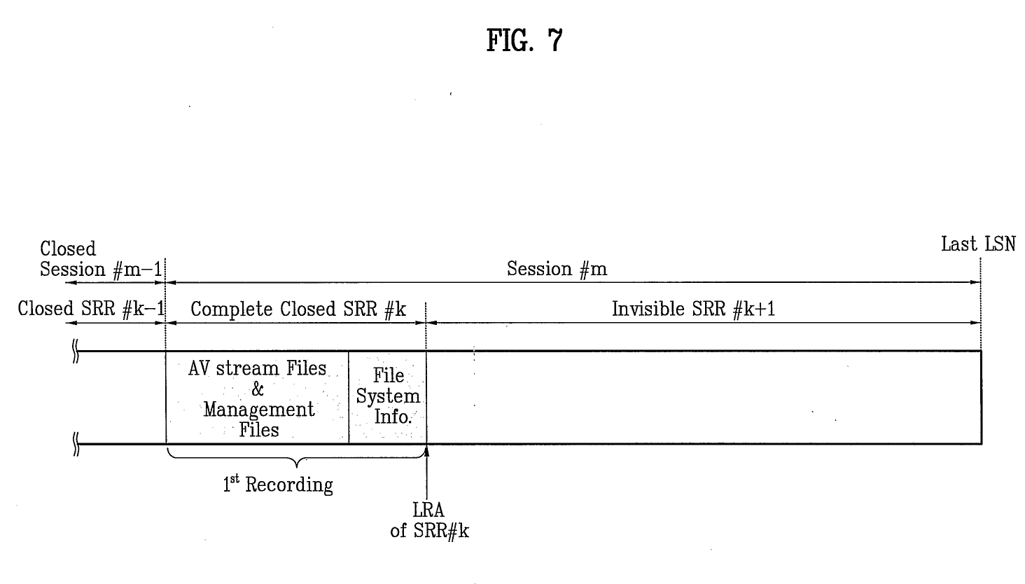

FIG. 7 illustrates an example of the present invention being applied to a disc having a multi-session. More specifically, referring to FIG. 7, when recording of a previous session (session #m−1) is completed, all of the SRRs within the corresponding session are closed. Therefore, within the SRRI, validly recorded file system information may be read from the LRA information of each SRR. Furthermore, when a current session (session #m) is opened after the completion of the previous session (session #m−1), by changing the SRR in which file system information is recorded to a closed SRR, as described above, the reliability can be enhanced when recovering the data.

Hereinafter, an optical recording and reproducing apparatus according to the present invention and a method for recording data on the optical disc by using the same will now be described with reference to FIG. 8. Referring to FIG. 8, the optical recording and reproducing apparatus basically includes a pick-up unit 11 for reading data, disc management information, and file system information recorded on the optical disc, a servo 14 controlling the operations of the pick-up unit 11, a signal processor 13 either recovering the reproduction signal received from the pick-up unit 11 to a desired signal value, or modulating a signal to be recorded to an optical disc recordable signal and transmitting the modulated signal to the pick-up unit 11, a memory 15 for temporarily storing the disc management information and file system information read from the optical disc, and a microcomputer 16 controlling the above operations. This basic structure is referred to as a recording and reproducing device 20.

Also, a controller 12 controls the overall operation of the optical recording and reproducing apparatus. The controller 12 receives a user command through a user interface and transmits the received user command to the microcomputer 16, so that operation of the apparatus can be controlled in accordance with the user command. Most particularly, the controller 12 uses the disc management information transmitted from the recording and reproducing device 20 and creates a recording and reproducing command. Thereafter, the controller 12 transmits the command back to the recording and reproducing device 20. In addition, an AV decoder and text subtitle (Text ST) decoder 17 performs final decoding of output data in accordance with the controls of the controller 12. And, in order to perform the function of recording a signal on the optical disc, an AV encoder 18 converts an input signal into a signal of a specific format (e.g., an MPEG-2 transport stream) depending upon the controls of the controller 12 and, then, provides the converted signal to the signal processor 13.

A method for recording data on a write-once optical disc by using the above-described optical recording and reproducing apparatus will now be described in detail. When the write-once optical disc is loaded, the controller 12 reads a recent (or latest) Sequential Recording Range Information (SRRI) from a disc management area and, then, verifies the LRA of the closed SRR. After verifying the file system information from the LRA of the verified closed SRR, the controller 12 uses the verified file system information to transmit a recording and reproducing (or writing and reading) command to the recording and reproducing device 20. After receiving the recording and reproducing command from the controller 20, the recording and reproducing device 20 performs recording and reproducing in accordance with the received command.

Furthermore, when performing recording, the controller 12 records the stream file and the management files on an open SRR. And, when the recording of the file system information is completed, the controller 12 changes the open SRR to a closed SRR and records the disc management information (SRRI) within the disc management area (TDMA) in accordance with the change in SRR. As the disc management information (SRRI) is updated according to the above-described process, data can be validly recovered by using the disc management information (SRRI) recorded during a next loading of the corresponding disc, even when critical problems such as a system error occur during a later recording process.

### INDUSTRIAL APPLICABILITY

By using the method for recording data on the optical disc associated with the file system information of the high density optical disc according to the present invention, valid data can be reproduced with more reliability, even when unexpected situations such as a system error occur, thereby enabling efficient recording and reproduction of the optical disc to be performed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for recording data on a recording medium having a user data area and a temporary disc management area, the method comprising:
recording AV stream files and management files in a data recordable area included in the user data area;
recording file system information in the data recordable area after the recordation of the management files, the file system information being associated with the AV stream files and the management files recorded in the data recordable area;
closing the data recordable area after the recordation of the file system information in the data recordable area; and
recording attribute information of the closed data area in the temporary disc management area, wherein the attribute information comprises last recorded address information of the closed data area.

2. The method of claim 1, wherein the data recordable area comprises an open sequential recording range.

3. The method of claim 2, wherein the attribute information stored in the temporary disc management area comprises sequential recording range information.

4. The method of claim 1, wherein the management files comprise at least one of information, menu, mark, playlist, and clip information files required for reproducing the AV stream files stored in the data recordable area.

5. The method of claim 1, wherein the file system information comprises at least one of volume structure information and file structure information.

6. The method of claim 5, wherein the volume structure information comprises volume structure descriptors and anchor information indicating locations of the volume structure descriptors.

7. The method of claim 5, wherein the file structure information comprises metadata files and a first file entry indicating locations of the metadata files.

8. The method of claim 7, wherein the first file entry comprises a metadata partition map if any one of the metadata files is partitioned, the metadata partition map indicating locations of the partitioned metadata file.

9. The method of claim 7, wherein the file structure information further comprises metadata mirror files and a second file entry indicating locations of the metadata mirror files.

10. A recording medium for recording data, comprising:
a temporary disc management area; and
a user data area comprising a data recordable area, the data recordable area being configured to store AV stream files and management files and to store file system information associated with the AV stream files and the management files, wherein the user data area is configured to be closed after the file system information is stored, and the temporary disc management area is configured to store attribute information of the closed data area, the attribute information comprising last recorded address information of the closed data area.

11. The recording medium of claim 10, wherein the data recordable are comprises an open sequential recording range, and the attribute information stored in the temporary disc management area comprises sequential recording range information.

12. The recording medium of claim 10, wherein the management files comprise at least one of information, menu, mark, playlist, and clip information files required for reproducing the AV stream files stored in the data recordable area.

13. The recording medium of claim 10, wherein the file system information comprises volume structure information and file structure information.

14. An apparatus for recording data on a recording medium having a user data area and a temporary disc management area, the apparatus comprising:
a driver configured to drive an optical recording device to record data on a recording medium; and
a controller configured to control the driver to record AV stream files and management files in a data recordable area included in the user data area and to record associated file system information in the data recordable area after the recordation of the management files, wherein the controller is configured to control the driver to close the data recordable area after the file system information is stored in the data recordable area and to store attribute information of the closed data area in the temporary disc management area, the attribute information comprising last recorded address information of the closed data area.

15. A method for reproducing data recorded on a recording medium having a user data area and a temporary disc management area, the method comprising:
reading attribute information of a closed data area from the temporary disc management area, wherein the closed data area is included in the user data area and the attribute information comprises last recorded address information of the closed data area;
reading file system information recorded in the closed data area using the last recorded address information; and
reproducing AV stream files recorded in the closed data area using the last recorded address information and the file system information.

16. The method of claim 15, wherein the file system information comprises at least one of volume structure information and file structure information.

17. The method of claim 16, wherein the volume structure information comprises volume structure descriptors and anchor information indicating locations of the volume structure descriptors.

18. The method of claim 16, wherein the file structure information comprises metadata files and a first file entry indicating locations of the metadata files.

19. The method of claim 18, wherein the file structure information further comprises metadata mirror files and a second file entry indicating locations of the metadata mirror files.

20. An apparatus for reproducing data recorded on a recording medium having a user data area and a temporary disc management area, the apparatus comprising:
a driver configured to drive an optical reproducing device to reproduce data recorded on the recording medium; and
a controller configured to control the driver to read attribute information of a closed data area from the temporary disc management area, to read file system information recorded in the closed data area using last recorded address information included in the attribute information, and to reproduce AV stream files recorded in the closed data area using the last recorded address information and the file system information, the closed data area being included in the user data area.
